(19) United States
(12) Patent Application Publication
(10) Pub. No.: US 2025/0352930 A1
(43) Pub. Date: Nov. 20, 2025

(54) FUEL FILTER ADAPTER

(71) Applicant: R.W. Beckett Corporation, North Ridgeville, OH (US)

(72) Inventors: Jeff Traczek, Sandusky, OH (US); Duane Wilson, Bellevue, OH (US); Jeffrey Naymik, Avon, OH (US); Alan Chmiel, Avon Lake, OH (US)

(21) Appl. No.: 19/213,291

(22) Filed: May 20, 2025

Related U.S. Application Data
(60) Provisional application No. 63/649,903, filed on May 20, 2024.

(51) Int. Cl. B01D 35/30; B01D 27/08; B01D 35/00

(52) U.S. Cl. CPC B01D 35/306; B01D 27/08; B01D 35/005

(57) ABSTRACT

A fuel filter adapter has an adapter body having a coupler with a threaded hole extending from mount-engagement end toward a filter-engagement end. External threads of the coupler on the filter-engagement end engage an internal thread of a spin-on fuel filter. A coupler fluid passage extends through the coupler from the mount-engagement end to the filter-engagement end. A mount-facing surface of the adapter body defines a mount sealing surface, and has opposite filter-facing surface. A body passage of the adapter body extends between the mount-facing and filter-facing surfaces, and are positioned between the coupler and a peripheral region of the adapter body. One or more mount engagement members extend from the mount-facing surface, and selectively engage one or more contact surfaces of the mount to limit a rotation of the adapter body about the axis with respect to the mount. A gasket seals the mount sealing surface to the mount.

### REFERENCE TO RELATED APPLICATIONS

This application claims the benefit of U.S. Provisional Application Ser. No. 63/649,903 filed May 20, 2024, entitled, “FUEL FILTER ADAPTER”, the contents of all of which are herein incorporated by reference in their entirety.

### FIELD

The present disclosure relates generally to fluid handling components, and more specifically to an adapter for selectively securing a spin-on fuel filter to a cartridge-style fuel filter base.

### BACKGROUND

Fuel storage tanks are often used to store and supply a flammable liquid for consumption. In the residential heating industry, for example, fuel oil storage tanks can be used to supply fuel oil to a residence for consumption in an oil furnace. The fuel oil, for example, can be transferred from the storage tank through a fuel filter apparatus to prevent particles or other contamination carried in the fuel from hindering operation of the oil furnace.

Conventionally, a fuel filter apparatus is configured to receive a particular configuration of fuel filter. Two styles of replaceable fuel filters are commonly available in the marketplace, namely, a cartridge filter, and a spin-on fuel filter. The cartridge filter is configured to be used with a cartridge fuel filter apparatus, and the spin-on fuel filter is configured to be used with a spin-on fuel filter apparatus, whereby the use of either style is not conventionally interchangeable. Replacement of either style of fuel filter is typically desired to be performed on a regular basis, or when flow through the fuel filter is impinged, such as when the fuel filter becomes fouled or dirty.

A conventional cartridge fuel filter apparatus 10 illustrated in FIG. 1A comprises a canister base 12 that is configured to receive a canister 14 in which a fuel filter cartridge (e.g., a so-called “drop-in” filter—not shown) is selectively positioned. The cartridge fuel filter apparatus 10 is configured to direct a flow of fuel through the fuel filter cartridge to provide filtration of the fuel. The canister 14 provides a selective seal to the canister base 12 via a securement apparatus 16 (e.g., a threaded bolt arrangement, a clamp, or other mechanism), whereby the securement apparatus selectively fixes the canister to the canister base. As such, the fuel filter cartridge is selectively sealed within the cartridge fuel filter apparatus 10 for filtration of fuel passed therethrough. The securement apparatus 16, for example, can comprise replaceable seals or o-rings positioned between the canister 14 and the canister base 12 to provide the selective sealing between the canister and the canister base. Upon a desired replacement of the fuel filter cartridge, the canister 14 can be removed from the canister base 12 via a removal of the securement apparatus 16, whereby a new fuel filter cartridge may be reinserted into the canister and the canister re-secured to canister base 12.

A conventional spin-on fuel filter apparatus 20 illustrated in FIG. 1B, on the other hand, provides a spin-on base 22 configured to receive a self-contained and spin-on fuel filter 24 that is both easily replaceable and disposable, whereby the conventional spin-on fuel filter apparatus is configured to direct a flow of the fuel through the spin-on fuel filter to provide filtration of the fuel. The spin-on fuel filter 24 contains a filter element (not shown) that is enclosed by a thin metal container 26, thus defining a self-contained filter. The spin-on base 22 of the spin-on fuel filter apparatus 20 typically comprises a threaded member (not shown), onto which the spin-on fuel filter 24 is threaded. The spin-on fuel filter 24 typically has an integral seal (not shown) to provide selective sealing between the thin metal container 26 of the spin-on fuel filter and the spin-on base 22, thus providing additional ease of maintenance. As such, the spin-on fuel filter 24 is fully disposable and replaceable, and does not re-use the canister 14 or require the replacement of the seals that are otherwise associated with the cartridge fuel filter apparatus 10 of FIG. 1A.

Conventionally, the canister base 12 of the cartridge fuel filter apparatus 10 of FIG. 1A and the spin-on base 22 of the spin-on fuel filter apparatus 20 of FIG. 1B have not permitted interchangeability between filter types. As such, changing from the utilization of the replaceable fuel filter cartridge designed for the cartridge fuel filter apparatus 10 of FIG. 1A to the spin-on fuel filter 24 designed for the spin-on fuel filter apparatus 20 of FIG. 1B has required dismounting of the canister base 12 from the storage tank for subsequent replacement with the spin-on base 22. thereof with the respective spin-on base or canister base. Such a changing of filter bases is inconvenient, time consuming, and can be fraught with deleterious spillages of fuel.

### SUMMARY

The present disclosure provides a fuel filter adapter configured to be selectively secured to a canister base to advantageously adapt the canister base utilized with a conventional cartridge filter apparatus to readily accept a spin-on fuel filter. The fuel filter adapter of the present disclosure, for example, readily permits interchangeability between cartridge filters and spin-on fuel filters without disconnection of the canister base from any fuel-containing apparatus to which the canister base may be connected. The following presents a simplified summary of the invention in order to provide a basic understanding of some aspects of the invention. This summary is not an extensive overview of the invention. It is intended neither to identify key or critical elements of the invention nor to delineate the scope of the invention. Rather, its primary purpose is merely to present one or more concepts of the invention in a simplified form as a prelude to the more detailed description that is presented later.

In accordance with one example aspect of the disclosure, a fuel filter adapter is provided for coupling a spin-on fuel filter to a mount configured for a conventional cartridge filter. The fuel filter adapter, for example, comprises an adapter body comprising a coupler, wherein the coupler extends along an axis and has a mount-engagement end and a filter-engagement end. The coupler, for example, comprises a threaded hole extending along the axis from the mount-engagement end toward the filter-engagement end, and an external thread extending along the axis from the filter-engagement end, wherein the external thread is configured to threadedly engage an internal thread of the spin-on fuel filter. The coupler, for example, further comprises one or more coupler fluid passages extending through the coupler from the mount-engagement end to the filter-engagement end.

In one example, the adapter body further has a mount-facing surface extending radially about the axis from the coupler to a peripheral region of the adapter body, wherein the mount-facing surface defines a mount sealing surface. The adapter body further has a filter-facing surface extending radially about the axis, wherein the filter-facing surface is opposite the mount-facing surface. Further, one or more body passages of the adapter body extend from the mount-facing surface to the filter-facing surface, wherein the one or more body passages are radially positioned about the axis between the coupler and the peripheral region of the adapter body.

In another example, the adapter body comprises one or more mount engagement members extending from the mount-facing surface, wherein the one or more body passages are radially positioned about the axis between the coupler and the peripheral region of the adapter body. The one or more mount engagement members, for example, are configured to selectively engage one or more contact surfaces of the mount to limit a rotation of the adapter body about the axis with respect to the mount. Further, the fuel filter adapter comprises a peripheral mount gasket configured to seat against the mount sealing surface.

In one example, the mount sealing surface comprises a peripheral mount sealing surface defined radially outward from the one or more body passages, wherein the peripheral mount gasket is configured to seat against the peripheral mount sealing surface. The mount sealing surface can further comprise a collar mount sealing surface that is radially positioned between the coupler and the one or more body passages, whereby the fuel filter adapter can further comprise a collar gasket. The collar gasket, for example, is configured to seat against the collar mount sealing surface.

The one or more mount engagement members, for example, can comprise four mount engagement members, and the one or more body passages can comprise four body passages, wherein the four mount engagement members and the four body passages are alternatingly spaced between the collar mount sealing surface and the peripheral mount sealing surface.

For example, the one or more contact surfaces are associated with one or more of a first fluid port and a second fluid port of the mount. The one or more mount engagement members, for example, are configured to selectively engage the one or more of the first fluid port and the second fluid port of the mount. In one example, the adapter body is configured to selectively fluidly couple the first fluid port and the spin-on fuel filter through the one or more coupler fluid passages, wherein the adapter body is further configured to selectively fluidly couple the spin-on fuel filter and the second fluid port through the one or more body passages.

The one or more coupler fluid passages, for example, can comprise a plurality of coupler fluid passages extending through the coupler generally parallel to the axis. Further, the one or more mount engagement members can comprise a plurality of mount engagement members, and the one or more body passages comprise a plurality of body passages that are respectively alternatingly positioned between the plurality of mount engagement members. The one or more mount engagement members, for example, can extend from the mount-facing surface approximately parallel to the axis.

In yet another example, the internal thread of the spin-on fuel filter is configured to selectively couple the spin-on fuel filter to the filter-facing surface of the adapter body, thereby selectively sealing a filter seal of the spin-on fuel filter to the filter-facing surface.

Further, a fastener can be provided in another example, whereby the fastener has a fastener thread configured to selectively threadedly engage the threaded hole of the coupler. Accordingly, the fastener is configured to selectively couple the adapter body to the mount, whereby the peripheral mount gasket selectively fluidly seals the mount sealing surface to a mount surface of the mount.

In accordance with another aspect of the disclosure, a fuel filtration apparatus is provided. The fuel filtration apparatus, for example, comprises a mount having a first fluid port, a second fluid port, and a mount surface. The fuel filtration apparatus further comprises an adapter body. The adapter body can comprise one or more body passages defined through the adapter body, and a mount-facing surface configured to be selectively coupled to the mount, wherein the mount-facing surface defines a mount sealing surface. The adapter body can further comprise one or more engagement members configured to selectively engage one or more of the first fluid port and the second fluid port, and a filter-facing surface generally opposite the mount-facing surface.

In one example, the adapter body further comprises a coupler, wherein the coupler extends along an axis and has a mount-engagement end and a filter-engagement end. The coupler, in one example, comprises a threaded hole extending along the axis from the mount-engagement end toward the filter-engagement end and an external thread extending along the axis from the filter-engagement end toward the filter-facing surface. The external thread, for example, is configured to threadedly engage an internal thread of a spin-on fuel filter to selectively couple the spin-on fuel filter to the filter-facing surface. The coupler, for example, further comprises one or more coupler fluid passages extending through the coupler from the mount-engagement end to the filter-engagement end. The one or more coupler fluid passages, for example, are configured to be fluidly coupled to the first fluid port, and wherein the adapter body is configured to define a fluid path from the first fluid port to the one or more coupler fluid passages to the spin-on fuel filter to the one or more body passages to the second fluid port.

Further, a fastener is configured to selectively engage the mount and a respective one of the threaded hole and a filter canister, thereby selectively coupling the one of the adapter body and the filter canister to the mount surface of the mount. The one or more engagement members, for example, are thus configured to limit a rotation of the adapter body with respect to the mount about the axis when the one or more engagement members selectively engage one or more of the first fluid port and the second fluid port.

The fuel filtration apparatus can further comprise a peripheral mount gasket configured to selectively fluidly seal the mount-facing surface of the adapter body to the mount surface of the mount. Further, in another example, a screw gasket is provided, wherein the fastener comprises a screw having a screw head, and wherein the screw gasket is configured to selectively fluidly seal the screw head to the mount.

The fuel filtration apparatus, for example, can further comprise a collar gasket, wherein the mount sealing surface further comprises a collar mount sealing surface that is radially positioned between the coupler and the one or more body passages, and wherein the collar gasket is configured to seat against the collar mount sealing surface.

In accordance with yet another aspect, a fuel filtration apparatus is provided comprising a mount having a first fluid port, a second fluid port, and a mount surface. An adapter body is provided having a mount-facing surface configured to be selectively coupled to the mount, a filter-facing surface generally opposing the mount-facing surface, and one or more body passages extending from the mount-facing surface to the filter-facing surface.

One or more mount engagement members, for example, are configured to selectively engage one or more of the first fluid port and the second fluid port, and a coupler having an external thread defined along an axis is provided. The coupler, for example, comprises one or more coupler fluid passages configured to be fluidly coupled to the first fluid port, wherein the external thread is configured to threadedly engage an internal thread of a spin-on fuel filter to selectively couple the spin-on fuel filter to the filter-facing surface. The adapter body is thus configured to define a fluid path from the first fluid port to the one or more coupler fluid passages to a spin-on fuel filter to the one or more body passages to the second fluid port.

Further, a fastener is configured to selectively engage the mount and a respective one of the adapter and a filter canister, thereby selectively coupling the respective adapter or filter canister to the mount surface of the mount. The one or more mount engagement members, for example, are configured to limit a rotation of the adapter with respect to the mount about the axis when the one or more mount engagement members selectively engage one or more of the first fluid port and the second fluid port.

In one example, the coupler extends along the axis and has a mount-engagement end and a filter-engagement end. The coupler further comprises a threaded hole extending along the axis from the mount-engagement end toward the filter-engagement end, wherein the fastener configured to selectively engage the mount and the threaded hole, thereby selectively coupling the adapter body to the mount surface of the mount.

The fuel filtration apparatus, for example, can further comprise a peripheral mount gasket, wherein the mount-facing surface comprises a peripheral mount sealing surface, and wherein the peripheral mount gasket is configured to selectively fluidly seal the peripheral mount sealing surface to the mount surface of the mount.

In another example, a collar gasket is further provided, wherein the mount-facing surface further comprises a collar mount sealing surface that is radially positioned between the coupler and the one or more body passages, and wherein the collar gasket is configured to seat against the collar mount sealing surface. Further, the one or more mount engagement members can comprise four mount engagement members, and the one or more body passages comprise four body passages, wherein the four mount engagement members and the four body passages are alternatingly spaced between the collar mount sealing surface and the peripheral mount sealing surface.

The above summary is merely intended to give a brief overview of some features of some embodiments of the present disclosure, and other embodiments may comprise additional and/or different features than the ones mentioned above. In particular, this summary is not to be construed to be limiting the scope of the present application. Thus, to the accomplishment of the foregoing and related ends, the disclosure comprises the features hereinafter described and particularly pointed out in the claims. The following description and the annexed drawings set forth in detail certain illustrative embodiments of the disclosure. These embodiments are indicative, however, of a few of the various ways in which the principles of the disclosure may be employed. Other objects, advantages and novel features of the disclosure will become apparent from the following detailed description of the disclosure when considered in conjunction with the drawings.

### BRIEF DESCRIPTION OF THE DRAWINGS

FIG. 1A is a front perspective view of a conventional cartridge fuel filter apparatus for use with a cartridge fuel filter.

FIG. 1B is a front perspective view of a spin-on fuel filter apparatus for use with a spin-on fuel filter.

FIG. 2 is a front perspective view of a fuel filter adapter coupling a spin-on fuel filter to a canister fuel filter base in accordance with various examples of the present disclosure.

FIG. 3 is an exploded front perspective view of fuel filtration apparatus having a fuel filter adapter in accordance with various examples of the present disclosure.

FIG. 4A is a top perspective view of an adapter body in accordance with various examples of the present disclosure.

FIG. 4B is a bottom perspective view of the adapter body of FIG. 4A in accordance with various examples of the present disclosure.

FIG. 5 is an exploded front elevation view of a fuel filtration apparatus including an fuel adapter apparatus in accordance with various examples of the present disclosure.

FIG. 6 is an exploded front elevation view of a fuel filter adapter apparatus in accordance with various examples of the present disclosure.

### DETAILED DESCRIPTION

The present disclosure is directed generally toward an adapter apparatus and system for adapting a cartridge fuel filter apparatus for accepting a spin-on fuel filter. Accordingly, the present disclosure will now be described with reference to the drawings, wherein like reference numerals may be used to refer to like elements throughout. It should be understood that the description of these aspects are merely illustrative and that they should not be interpreted in a limiting sense. In the following description, for purposes of explanation, numerous specific details are set forth in order to provide a thorough understanding of the present disclosure. It will be evident to one skilled in the art, however, that the present disclosure may be practiced without these specific details.

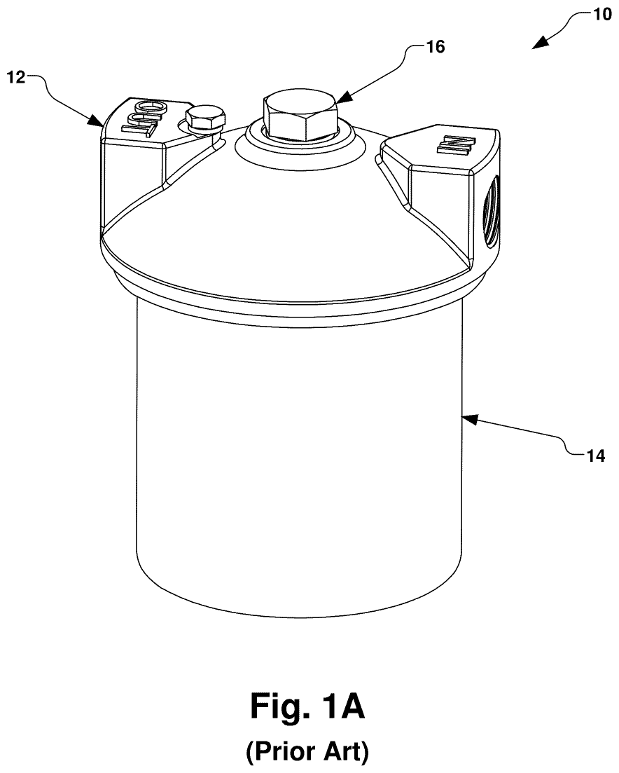

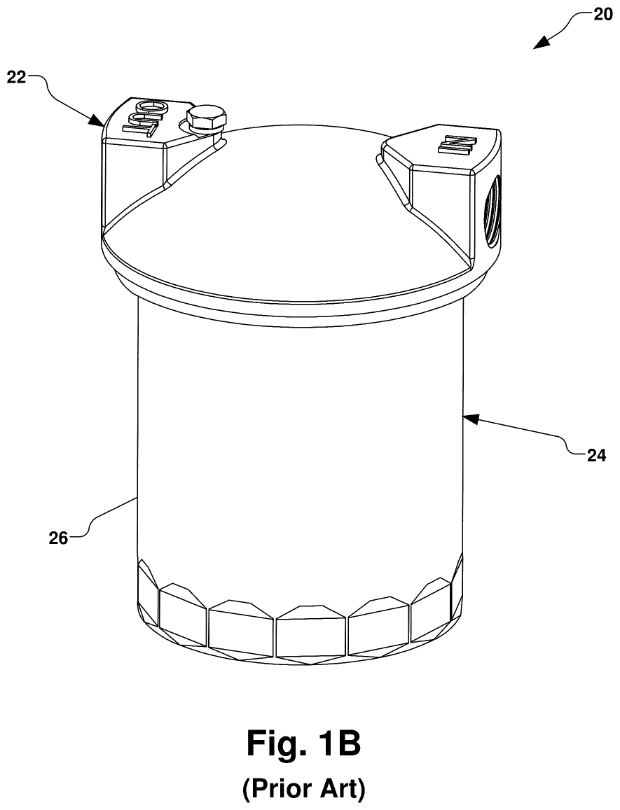

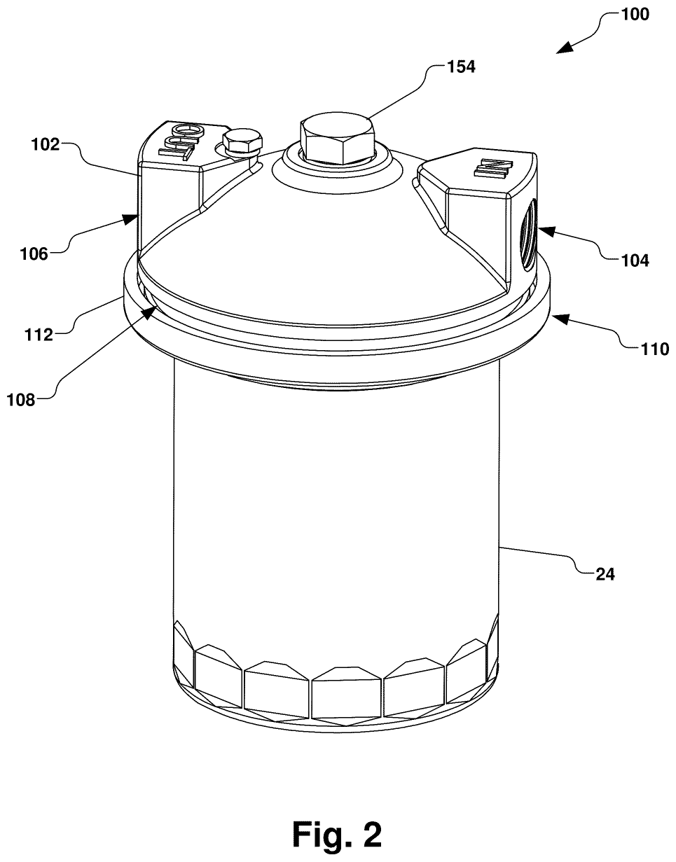

The present disclosure thus seeks to eliminate previous issues with having to stock multiple kits and/or discard portions of kits, based on the type of fuel filter used. In accordance with one example, a fuel filtration apparatus 100 is provided as illustrated in FIG. 2. The fuel filtration apparatus 100, for example, comprises a mount 102 having a first fluid port 104, a second fluid port 106, and a mount surface 108. In one non-limiting example, the mount 102 can comprise a conventional cartridge base, such as the canister base 12 as illustrated in FIG. 1A.

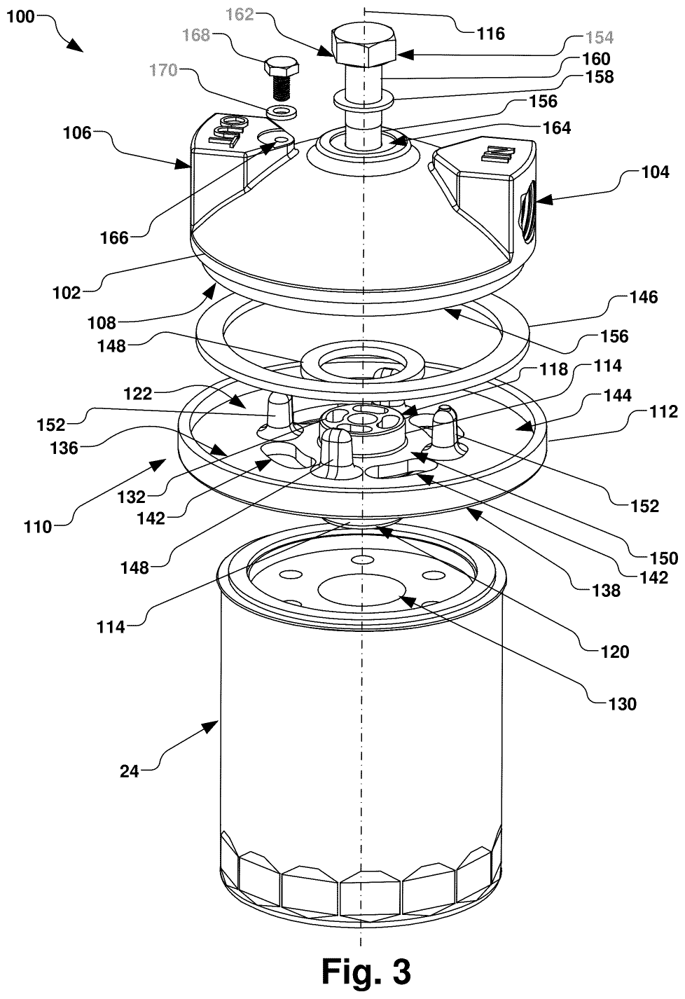

In accordance with one example, the fuel filtration apparatus 100 of FIG. 2 further comprises fuel filter adapter 110 comprising an adapter body 112, whereby the adapter body is configured to selectively couple a conventional spin-on fuel filter 24 to the mount 102, as will be further described in greater detail hereafter. The adapter body 112, for example, can be comprised of a cast metal, such as one of aluminum or steel. For example, as illustrated in FIG. 3, the adapter body 112 comprises a coupler 114, wherein the coupler extends along an axis 116 and has a mount-engagement end 118 and a filter-engagement end 120.

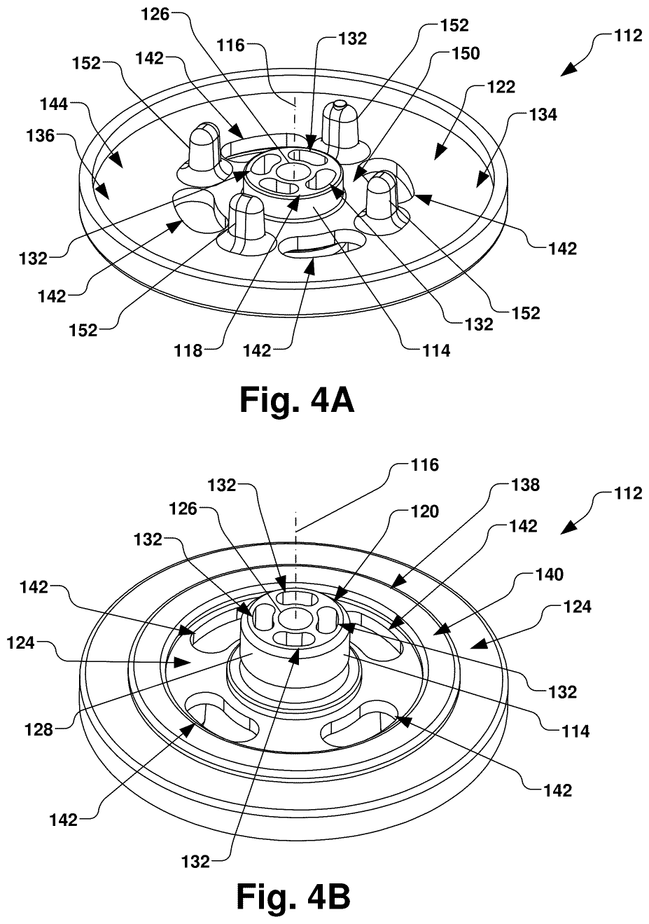

The adapter body 112, for example, comprises a mount-facing surface 122 illustrated in FIG. 4A, and a filter-facing surface 124 illustrated in FIG. 4B. For example, the coupler 114 of the adapter body 112 comprises a threaded hole 126 illustrated in FIG. 4A, whereby in the threaded hole extends along the axis 116 from the mount-engagement end 118 toward the filter-engagement end 120 illustrated in FIG. 4B. As illustrated in the present example, the threaded hole 126 is a thru-hole extending from the mount-engagement end 118 of FIG. 4A to the filter-engagement end 120 illustrated in FIG. 4B. However, the present disclosure also contemplates the threaded hole 126 of FIG. 4A being a blind hole, whereby the threaded hole does not extend entirely to the filter-engagement end 120 of FIG. 4B.

An external thread 128 of the coupler 114 extends along the axis 116 from the filter-engagement end 120, wherein the external thread is configured to threadedly engage an internal thread 130 of the spin-on fuel filter 24 shown in FIG. 3. The internal thread 130 of the spin-on fuel filter 24, for example, is configured to selectively couple the spin-on fuel filter to the filter-facing surface 124 of the adapter body 112, thereby selectively sealing a filter seal of the spin-on fuel filter to the filter-facing surface. The coupler 114, for example, further comprises one or more coupler fluid passages 132 extending through the coupler from the mount-engagement end 118 to the filter-engagement end 120. The one or more coupler fluid passages 132, for example, extend generally parallel to the axis 116. The mount-facing surface 122 illustrated in FIG. 4A, for example, further extends radially about the axis 116 from the coupler 114 to a peripheral region 134 of the adapter body 112, wherein the mount-facing surface generally defines a mount sealing surface 136. The mount sealing surface 136, for example, can be approximately planar.

As illustrated in FIG. 4B, the filter-facing surface 124 extends radially about the axis 116, wherein the filter-facing surface is generally opposite the mount-facing surface 122 of FIG. 4A. The filter-facing surface 124, for example, can be approximately planar. Alternatively, the filter-facing surface 124 may have a non-planar shape 138 and may comprise one or more features 140 that are proud of the remainder of the filter-facing surface 128, as illustrated in the example shown in FIG. 4B. The internal thread 130 of the spin-on fuel filter 24, for example, is configured to selectively couple the spin-on fuel filter to the filter-facing surface 124 of the adapter body 112, thereby selectively sealing a filter seal of the spin-on fuel filter to the filter-facing surface.

The adapter body 112, for example, further comprises one or more body passages 142 extending from the mount-facing surface 122 to the filter-facing surface 124, wherein the one or more body passages are radially positioned about the axis 116 between the coupler 114 and the peripheral region 134 of the adapter body. The mount sealing surface 136, for example, comprises a peripheral mount sealing surface 144 that is defined radially outward from the one or more body passages 142, whereby a peripheral mount gasket 146 illustrated in FIG. 3 is configured to seat against the peripheral mount sealing surface to seal fluid from flowing beyond the peripheral mount sealing surface.

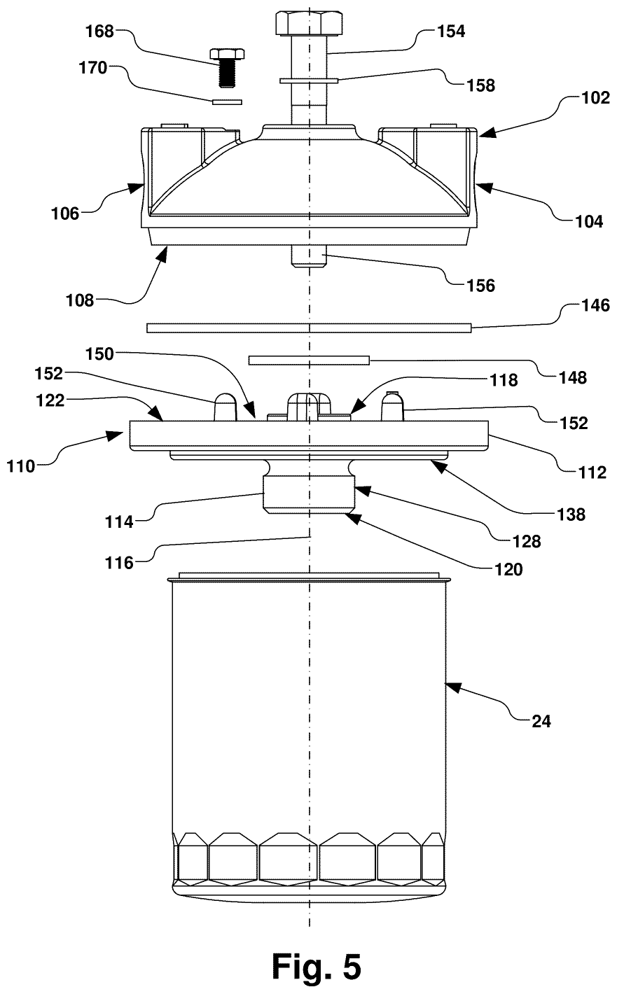

A collar gasket 148 may be further provided, whereby the mount sealing surface 136 further comprises a collar mount sealing surface 150 that is radially positioned between the coupler 114 and the one or more body passages 142, as illustrated in FIG. 4A. The collar gasket 148 shown in FIGS. 3 and 5, for example, is configured to seat against the collar mount sealing surface 150, whereby the collar gasket and the peripheral mount gasket 146 are configured to provide a fluid seal associated with the one or more body passages 142. The adapter body 112, for example, is thus configured to selectively fluidly couple the first fluid port 104 and the spin-on fuel filter 24 through the one or more coupler fluid passages 132, wherein the adapter body is further configured to selectively fluidly couple the spin-on fuel filter and the second fluid port 106 through the one or more body passages 142.

In accordance with one aspect of the present disclosure, a rotation of the adapter body 112 about the axis 116 with respect to the mount 102, for example, is further provided by one or more mount engagement members 152 extending from the mount-facing surface 122. The one or more mount engagement members 152, for example, are radially and circumferentially positioned with respect to the axis 116 between the coupler 114 and the peripheral region 134 of the adapter body 112, and can extend from the mount-facing surface 122 approximately parallel to the axis 116. In the present example, the one or more mount engagement members 152 comprise four mount engagement members that are alternatingly spaced between four body passages 142. The one or more mount engagement member 152, for example, are configured to selectively engage one or more contact surfaces of the mount 102 of FIGS. 3 and 5, thus limiting the rotation of the adapter body 112 about the axis 116.

The one or more contact surfaces of the mount 102, for example, can be associated with one or more of the first fluid port 104 and the second fluid port 106 thereof, wherein the one or more mount engagement members 152 are configured to selectively engage the one or more of the first fluid port and the second fluid port of the mount. For example, the one or more mount engagement members 152 of FIG. 3 are configured to limit a rotation of the fuel filter adapter 110 with respect to the mount 102 about the axis 116 by selectively engaging one or more of the first fluid port 104 and the second fluid port 106 (e.g., external extrusions within the mount).

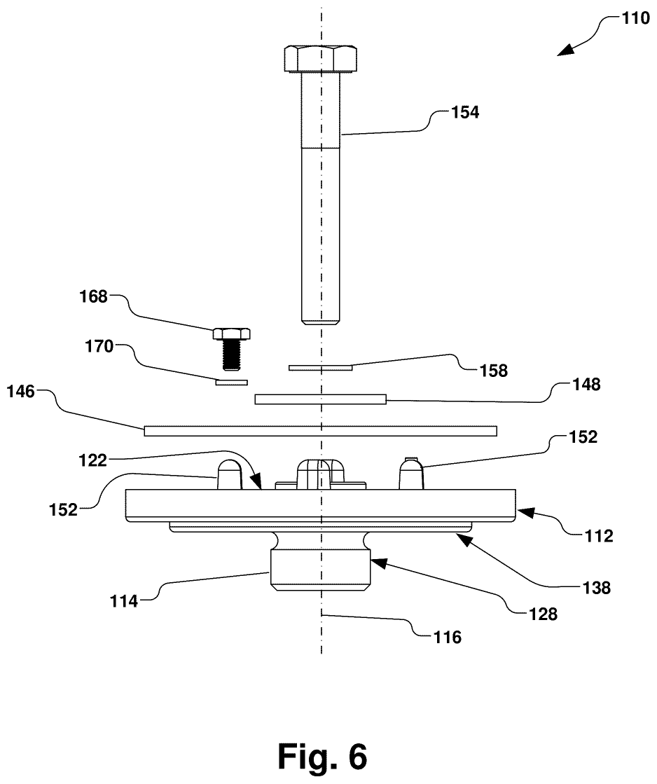

In accordance with another example of the disclosure, the fuel filter adapter 110 comprises a fastener 154, whereby the fastener has a fastener thread 156 configured to selectively threadedly engage the threaded hole 126 of the coupler 114. The fastener 154 of FIGS. 2-3 and 5-6 can be of any suitable length, whereby the fastener can selectively couple either of the conventional filter canister 14 of FIG. 1A and the fuel filter adapter 110 of the present disclosure to the mount surface 108 of the mount 102. The fastener 154 of the fuel filter adapter 110 shown in FIG. 6, for example, is configured to selectively couple the adapter body 112 to the mount 102 of FIGS. 2, 3 and 5, whereby the peripheral mount gasket 146 selectively fluidly seals the mount sealing surface 136 to mount surfaces 108 of the mount. The one or more mount engagement members 152, for example, are thus configured to limit the rotation of the adapter body 112 with respect to the mount 102 upon tightening the fastener 154, whereby the one or more engagement members selectively engage one or more of the first fluid port 104 and the second fluid port 106 to substantially prevent such rotation.

In another example, a screw gasket 158 is provided, wherein the fastener 154 comprises a screw 160 having a screw head 162, and wherein the screw gasket is configured to selectively fluidly seal the screw head to an external surface 164 the mount 102.

The mount 102, for example, can further comprise a bleed port 166 and a bleed screw 168, wherein the bleed screw threadedly engages the bleed port and is configured to selectively flow the fluid from the spin-on fuel filter 24 through the one or more body passages 142 through the bleed port. A bleed port gasket 170, for example, can be further configured to selectively fluidly seal the bleed screw 168 to the mount 102 and can be comprised of a fuel-resistant material. Any of the bleed port gasket 170, the peripheral mount gasket 146, or the collar gasket 148, for example, can be comprised of a generally resilient material and fuel-resistant material such as rubber, neoprene, cork, or other any synthetic or natural material suitable for use with fuel oil. For example, any gasket described herein can be comprised of a fuel-resistant material, such as a material that is chemically resistant to one of more of diesel fuel and bio-diesel fuel.

In one alternative example, the fastener 154 can alternatively, or in addition, comprise a clamp or other clamping mechanism (not shown) that can be configured to selectively engage the mount 102 and the adapter body 112 for the selective coupling therebetween.

Although the disclosure has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the disclosure. In addition, while a particular feature of the disclosure may have been disclosed with respect to only one of several embodiments, such feature may be combined with one or more other features of the other embodiments as may be desired and advantageous for any given or particular application.

What is claimed is:

1. A fuel filter adapter for coupling a spin-on fuel filter to a mount for a cartridge filter, the fuel filter adapter comprising:
an adapter body comprising:
a coupler, wherein the coupler extends along an axis and has a mount-engagement end and a filter-engagement end, wherein the coupler comprises:
a threaded hole extending along the axis from the mount-engagement end toward the filter-engagement end;
an external thread extending along the axis from the filter-engagement end, wherein the external thread is configured to threadedly engage an internal thread of the spin-on fuel filter; and
one or more coupler fluid passages extending through the coupler from the mount-engagement end to the filter-engagement end;
a mount-facing surface extending radially about the axis from the coupler to a peripheral region of the adapter body, wherein the mount-facing surface defines a mount sealing surface;
a filter-facing surface extending radially about the axis, wherein the filter-facing surface is opposite the mount-facing surface;
one or more body passages extending from the mount-facing surface to the filter-facing surface, wherein the one or more body passages are radially positioned about the axis between the coupler and the peripheral region of the adapter body;
one or more mount engagement members extending from the mount-facing surface, wherein the one or more body passages are radially positioned about the axis between the coupler and the peripheral region of the adapter body and are configured to selectively engage one or more contact surfaces of the mount to limit a rotation of the adapter body about the axis with respect to the mount; and
a peripheral mount gasket configured to seat against the mount sealing surface.

2. The fuel filter adapter of claim 1, wherein the mount sealing surface comprises a peripheral mount sealing surface defined radially outward from the one or more body passages, wherein the peripheral mount gasket is configured to seat against the peripheral mount sealing surface.

3. The fuel filter adapter of claim 2, further comprising a collar gasket, wherein the mount sealing surface further comprises a collar mount sealing surface that is radially positioned between the coupler and the one or more body passages, and wherein the collar gasket is configured to seat against the collar mount sealing surface.

4. The fuel filter adapter of claim 3, wherein the one or more mount engagement members comprise four mount engagement members, and wherein the one or more body passages comprise four body passages, wherein the four mount engagement members and the four body passages are alternatingly spaced between the collar mount sealing surface and the peripheral mount sealing surface.

5. The fuel filter adapter of claim 1, wherein the one or more contact surfaces are associated with one or more of a first fluid port and a second fluid port of the mount, and wherein the one or more mount engagement members are configured to selectively engage the one or more of the first fluid port and the second fluid port of the mount.

6. The fuel filter adapter of claim 5, wherein the adapter body is configured to selectively fluidly couple the first fluid port and the spin-on fuel filter through the one or more coupler fluid passages, and wherein the adapter body is further configured to selectively fluidly couple the spin-on fuel filter and the second fluid port through the one or more body passages.

7. The fuel filter adapter of claim 1, wherein the one or more coupler fluid passages comprise a plurality of coupler fluid passages extending through the coupler generally parallel to the axis.

8. The fuel filter adapter of claim 1, wherein the one or more mount engagement members comprise a plurality of mount engagement members, and wherein the one or more body passages comprise a plurality of body passages that are respectively alternatingly positioned between the plurality of mount engagement members.

9. The fuel filter adapter of claim 1, wherein the one or more mount engagement members extend from the mount-facing surface approximately parallel to the axis.

10. The fuel filter adapter of claim 1, wherein the internal thread of the spin-on fuel filter is configured to selectively couple the spin-on fuel filter to the filter-facing surface of the adapter body, thereby selectively sealing a filter seal of the spin-on fuel filter to the filter-facing surface.

11. The fuel filter adapter of claim 1, further comprising a fastener having a fastener thread configured to selectively threadedly engage the threaded hole of the coupler, whereby the fastener is configured to selectively couple the adapter body to the mount, wherein the peripheral mount gasket selectively fluidly seals the mount sealing surface to a mount surface of the mount.

12. A fuel filtration apparatus, comprising:
a mount having a first fluid port, a second fluid port, and a mount surface;
an adapter body comprising:
one or more body passages defined through the adapter body;
a mount-facing surface configured to be selectively coupled to the mount, wherein the mount-facing surface defines a mount sealing surface;
one or more engagement members configured to selectively engage one or more of the first fluid port and the second fluid port;
a filter-facing surface generally opposing the mount-facing surface;
a coupler, wherein the coupler extends along an axis and has a mount-engagement end and a filter-engagement end, wherein the coupler comprises:
a threaded hole extending along the axis from the mount-engagement end toward the filter-engagement end;
an external thread extending along the axis from the filter-engagement end toward the filter-facing surface, wherein the external thread is configured to threadedly engage an internal thread of a spin-on fuel filter to selectively couple the spin-on fuel filter to the filter-facing surface; and
one or more coupler fluid passages extending through the coupler from the mount-engagement end to the filter-engagement end, wherein the one or more coupler fluid passages are configured to be fluidly coupled to the first fluid port, and wherein the adapter body is configured to define a fluid path from the first fluid port to the one or more coupler fluid passages to the spin-on fuel filter to the one or more body passages to the second fluid port; and
a fastener configured to selectively engage the mount and a respective one of the threaded hole and a filter canister, thereby selectively coupling the one of the adapter body and the filter canister to the mount surface of the mount, and wherein the one or more engagement members are configured to limit a rotation of the adapter body with respect to the mount about the axis when the one or more engagement members selectively engage one or more of the first fluid port and the second fluid port.

13. The fuel filtration apparatus of claim 12, further comprising a peripheral mount gasket configured to selectively fluidly seal the mount-facing surface of the adapter body to the mount surface of the mount.

14. The fuel filtration apparatus of claim 12, further comprising a screw gasket, wherein the fastener comprises a screw having a screw head, wherein the screw gasket is configured to selectively fluidly seal the screw head to the mount.

15. The fuel filtration apparatus of claim 12, further comprising a collar gasket, wherein the mount sealing surface further comprises a collar mount sealing surface that is radially positioned between the coupler and the one or more body passages, and wherein the collar gasket is configured to seat against the collar mount sealing surface.

16. A fuel filtration apparatus, comprising:
a mount having a first fluid port, a second fluid port, and a mount surface;
an adapter body comprising:
a mount-facing surface configured to be selectively coupled to the mount;
a filter-facing surface generally opposite the mount-facing surface;
one or more body passages extending from the mount-facing surface to the filter-facing surface;
one or more mount engagement members configured to selectively engage one or more of the first fluid port and the second fluid port;
a coupler having an external thread defined along an axis, wherein the coupler comprises one or more coupler fluid passages configured to be fluidly coupled to the first fluid port, wherein the external thread is configured to threadedly engage an internal thread of a spin-on fuel filter to selectively couple the spin-on fuel filter to the filter-facing surface, and wherein the adapter body is configured to define a fluid path from the first fluid port to the one or more coupler fluid passages to a spin-on fuel filter to the one or more body passages to the second fluid port; and
a fastener configured to selectively engage the mount and a respective one of the adapter and a filter canister, thereby selectively coupling the respective adapter or the filter canister to the mount surface of the mount, and wherein the one or more mount engagement members are configured to limit a rotation of the adapter with respect to the mount about the axis when the one or more mount engagement members selectively engage one or more of the first fluid port and the second fluid port.

17. The fuel filtration apparatus of claim 16, wherein the coupler extends along the axis and has a mount-engagement end and a filter-engagement end, wherein the coupler further comprises a threaded hole extending along the axis from the mount-engagement end toward the filter-engagement end, wherein the fastener configured to selectively engage the mount and the threaded hole, thereby selectively coupling the adapter body to the mount surface of the mount.

18. The fuel filtration apparatus of claim 16, further comprising a peripheral mount gasket, wherein the mount-facing surface comprises a peripheral mount sealing surface, wherein the peripheral mount gasket is configured to selectively fluidly seal the peripheral mount sealing surface to the mount surface of the mount.

19. The fuel filtration apparatus of claim 18, further comprising a collar gasket, wherein the mount-facing surface further comprises a collar mount sealing surface that is radially positioned between the coupler and the one or more body passages, and wherein the collar gasket is configured to seat against the collar mount sealing surface.

20. The fuel filtration apparatus of claim 19, wherein the one or more mount engagement members comprise four mount engagement members, and wherein the one or more body passages comprise four body passages, wherein the four mount engagement members and the four body passages are alternatingly spaced between the collar mount sealing surface and the peripheral mount sealing surface.
